(19) United States
(12) Patent Application Publication
(10) Pub. No.: US 2008/0271619 A1
(43) Pub. Date: Nov. 6, 2008

(54) Printing Blanket

(75) Inventors: Peter Fajmann, Herzogenburg (AT); Susanne Paleczek, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Oesterreichische Banknoten-und Sicherheitsdruck GmbH, Wien (AT)

(21) Appl. No.: 11/914,299

(22) PCT Filed: May 10, 2006
(86) PCT No.: PCT/AT06/00191

§ 371 Date: Jun. 6, 2008

(30) Foreign Application Priority Data
May 10, 2005 (AT) A 791/2005

(51) Int. Cl. B41F 9/00; B41M 1/10

(52) U.S. Cl. 101/153; 101/170

(57) ABSTRACT

In order to subject optically variable elements to lower stresses in a printing blanket (1) for intaglio printing having at least one first zone (11) with a first roughness, at least one second zone (12) has a predeterminable second roughness lower than the first roughness and/or a predetermined recess (15) and/or a predeterminable modulus of elasticity lower than in the first zone.

The invention relates to a printing blanket for intaglio printing, comprising at least one first region with a first roughness.

In intaglio printing, which is also known as steel engraving printing, high contact pressures are employed, whereby a tactile print image is produced which is not achieved using other conventional printing methods. This tactility represents a security feature, for which reason intaglio printing is conventionally used in the printing of security documents, for example bank notes, bonds, certificates or the like. Owing to the high contact pressure the security document is flattened during the printing process and changes in size. An approximately uniform change in size, and therewith an adherence to predeterminable tolerances, can be achieved by the use of printing blankets with a rough surface, the structure of the printing blanket being impressed on the side that opposes the printed side. If a film element is applied to this side, the structure of the printing blanket is also transferred to the film element, whereby an intensive loss in film quality in terms of its brightness properties usually results. A loss in information content also occurs in the process, whereby the security value of the film element is reduced.

The object of the invention is to disclose a printing blanket of the type mentioned in the introduction in which the known drawbacks are avoided and with which security documents with applied film elements can be printed using intaglio printing while protecting the film elements.

According to the invention this is achieved in that a predeterminable second roughness that is lower than the first roughness and/or a predeterminable indentation and/or a predeterminable module of elasticity that is lower than in the first region is provided in at least one second region.

This results in the advantage that only a slight change in the surface structure of the film element occurs, with the brightness properties of the film element being largely retained. A lower partial pressure can be achieved by way of the second region, whereby damage to the part of the security document that comes into contact with the second region can be largely avoided. The surface structure can also be substantially retained in other elements by means of the second region. This has proven to be advantageous particularly with optically variable elements, wherein an effect color for example can be provided in addition to an effect film. The optically variable element can be arranged on the side to be printed or the side that opposes this side. In particular it is also possible for both sides of the security document to comprise intaglio printing.

In a development it may be provided that the second region is arranged in the printing zone and is constructed as a receiver for at least one second section of an optically variable element, in particular an effect film or an effect color, of a security document, interaction between the receiver and the optically variable element during the printing process being provided. It can thereby be ensured that the quality of the optically variable element is substantially not impaired during the printing process, it being possible to apply the optically variable element before the printing step with the printing blanket. Printing of a portion of the optically variable element can also be provided in this case.

According to a further embodiment of the invention it can be provided that a substantially constant passage is constructed between the first region and the second region, whereby erratic changes in the stressing of the security element during the printing process, which could lead to damage to the security document, are largely avoided.

The invention also relates to method for printing a security document using the intaglio printing method, the security document comprising at least one optically variable element, in particular an effect film or an effect color, and an impression cylinder comprising a printing blanket with at least one first region with a first roughness being arranged opposite a plate cylinder.

A further object of the invention is to disclose a method of the type mentioned above in which the known drawbacks are avoided and with which security documents with applied film elements can be printed using intaglio printing while protecting the film elements.

According to the invention this is achieved in that during the printing process the optically variable element is, at least in certain sections, brought into contact with a second region of the printing blanket, the second region comprising a predeterminable second roughness that is lower than the first roughness and/or a predeterminable depth and/or a predeterminable module of elasticity that is lower than in the first region.

This results in the advantage that only a slight change in the surface structure of the optically variable elements occurs, the properties of the optically variable element being largely retained. A lower partial pressure can be achieved by way of the second region, whereby damage to the part of the security document that comes into contact with the second region, in particular the optically variable element, can be largely avoided. The optically variable element can be arranged on the side to be printed or the side opposing this side. In particular it is possible for both sides of the security document to comprise intaglio printing.

In a further embodiment of the invention it may be provided that, after application of the optical variable element to the security document, the side of the security document that opposes the optically variable element is printed using the intaglio printing method, whereby the optically variable element can in particular be applied as early as during paper production and can optionally be at least partially embedded in the paper.

In a development of the invention it can be provided that in a predeterminable first section the optically variable element is brought into contact with the first region and in a predeterminable second section it is brought into contact with the second region. A surface structure of the optically variable element is produced in the first section that is different from that of the second section, whereby a further security feature can be formed.

The invention will be described in more detail with reference to the accompanying drawings, in which embodiments are illustrated and in which:

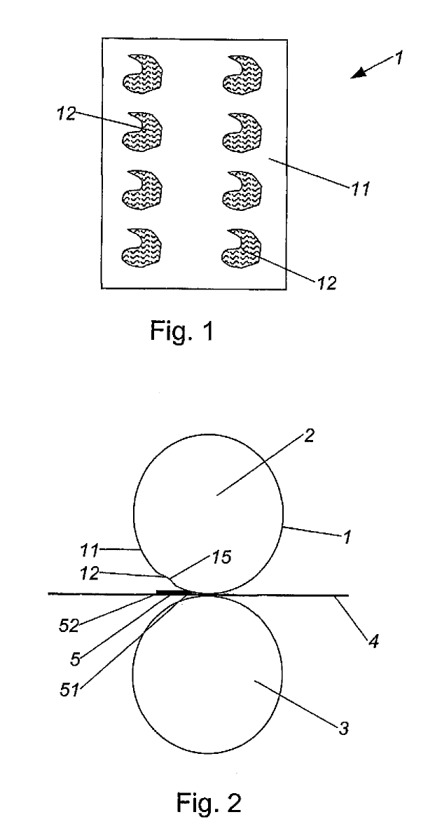

FIG. 1 shows a plan view of an embodiment of a printing blanket according to the invention, and

FIG. 2 shows a schematic side view of a plate cylinder, an impression cylinder and a security document.

FIG. 1 shows an embodiment of a printing blanket 1 according to the invention for intaglio printing. In intaglio printing, which is also known as steel engraving printing, high contact pressures are employed, whereby a tactile print image is produced which is not achieved using other conventional printing methods. This tactility represents a security feature, for which reason intaglio printing is conventionally used in the printing of security documents 4, for example bank notes, bonds, certificates or the like. FIG. 2 schematically shows a construction of a plate cylinder 3, an impression cylinder 2 with a printing blanket 1, and a security document 4. Owing to the high contact pressure the security document 4 is flattened during the printing process and changes in size. An approximately uniform change in size, and therewith an adherence to predeterminable tolerances, can be achieved by the use of printing blankets 1 with a rough surface, the structure of the printing blanket 1 being impressed on the side of the security document 4 that opposes the printed side. Use of a printing blanket 1 with a smooth surface leads to intolerable register tolerances, for which reason there are reservations among experts regarding the use of printing blankets 1 of this kind.

The printing blanket 1 comprises at least one first region 11 with a first roughness, this first roughness ensuring the adherence to the predeterminable tolerance. The first region 11 has a rough surface. The printing blanket 1 shown in FIG. 1 comprises a cohesive first region 11. In other embodiments the first region 11 can also comprise sections that are separate from each other.

At least one second region 12 is also provided, the second region 12 having a surface characteristic that differs from the first region 11. This different surface characteristic achieves a different impression of the printing blanket 1 on the security document 4 than in the first region 11. The second region 12 can in particular have a predeterminable second roughness that is lower than the first roughness and/or a predeterminable indentation 15 and/or a predeterminable module of elasticity that is lower than in the first region 11. In this case the second region 12 differs from the first region to an extent that exceeds the manufacturing tolerances, it being possible in particular to consciously produce and predetermine the differences in surface characteristic. In FIG. 2 the second region 12 has an indentation 15 compared to the first region 11. This embodiment has been selected owing to the fact that it is easy to illustrate.

The second region 12 can be formed as early as during production of the printing blanket 1 or in a subsequent operation by partially changing the surface. If the second region 12 has a lesser roughness, in particular if it is constructed with a substantially smooth surface, the second region 12 can be produced with a rough surface by partial cold-vulcanization of printing blankets 1. The surface of a printing blanket 1 can also be changed by an imprint, it being possible to provide conventional printing methods, in particular screen printing. In other embodiments the use of adhesive films or laminates can be provided for forming the second region 12. Combinations of the above-described treatments of a printing blanket 1 with a rough surface may also be provided to form the second regions 12. For a high service life of the printing blanket 1 the second surface 12 should have thermal stability up to about 80° C., high print stability and high extension stability.

The second region 12 can be provided for interaction with an optically variable element 5, in particular an effect film or an effect color, of the security document 4 during the printing process. In the process impressing of the surface structure of the first region 11 into the optically variable element 5 can be effectively prevented, it being possible to largely avoid a change in the optically variable element 5 by the different surface characteristic of the second region 12.

A substantially constant passage can be formed between the first region 11 and the second region 12. This can ensure that erratic changes in the stressing of the security element during the printing process, which could lead to damage to the security document, are largely avoided.

During the printing process the optically variable element 5 is, at least in certain sections, brought into contact with a second region 12 of the printing blanket 1. In the process the optically variable element 5 is passed through the nip between the plate cylinder 3 and the impression cylinder 2. The optically variable element 5 can be arranged on the side adjoining the impression cylinder or on the side of the security document 4 adjoining the plate cylinder 3.

Using this method in which an unintentional change in the optically variable element can be avoided, it is possible to print both sides of the security document 4, after application of the optically variable element 5 to the security document 4, by means of intaglio printing. In the process the intaglio printing can in particular overlap the optically variable element 5, at least in certain sections, whereby a high level of security is achieved in the security document.

It may also be provided that in a predeterminable first section 51 the optically variable element 5 is brought into contact with the first region 11 and in a predeterminable second section 52 it is brought into contact with the second region 12. The optically variable element 5 is changed thereby in the first section 51 during the printing process, but is left substantially unchanged in the second section. This difference in the optically variable element 5 constitutes a further security feature. The first section and the second section can, for example, be formed figuratively or to form a code.

The second region 12 is arranged in the printing zone, the printing zone being the zone in which the security document 4 is printed during the printing process. The second region 12 can be constructed as a receiver for at least the second section 52 of an optically variable element 5, in particular an effect film or an effect color, of a security document 4. The second region 12 can comprise a plurality of receivers, which are arranged in a grid, in particular if a plurality of security documents 4 is printed simultaneously during the printing process.

1.-6. (canceled)

7. A printing blanket for intaglio printing, comprising:
at least one first region having a rough surface characteristic; and
at least one second region having a surface characteristic which is different from the surface characteristic of the first region, wherein the second region is arranged in a printing area of a security document and is configured as a receiver for at least a section of an optically variable element of the security document, wherein the second region comprises a plurality of said receiver which are arranged in grid formation.

8. The printing blanket of claim 7, wherein the second region has a surface roughness which is lower than a surface roughness of the first region.

9. The printing blanket of claim 7, wherein the second region has a predefined depression.

10. The printing blanket of claim 7, wherein the second region has a predefined modulus of elasticity which is lower than a predefined modulus of elasticity of the first region.

11. The printing blanket of claim 7, wherein the section of the optically variable element of the security document is an effect film or an effect color.

12. The printing blanket of claim 7, wherein the first region is a cohesive region.

13. The printing blanket of claim 7, wherein the first region is composed of separate sections.

14. The printing blanket of claim 7, wherein the first region and the second region are separated by a substantially continuous transition.

15. A method for printing a security document by means of intaglio printing, comprising the steps of:
applying an optically variable element on a security document;
providing a printing blanket with a first region having a rough surface characteristic, and a second region having a surface characteristic which is different from the surface characteristic of the first region; and
contacting the optically variable element of a security document with at least some sections of the second region of the printing blanket.

16. The method of claim 15, wherein the second region has a surface roughness which is lower than a surface roughness of the first region.

17. The method of claim 15, wherein the second region has a predefined depression.

18. The method of claim 15, wherein the second region has a predefined modulus of elasticity which is lower than a predefined modulus of elasticity of the first region.

19. The method of claim 15, further comprising the step of printing a side of the security document in opposition to the optically variable element by means of intaglio printing after the applying step.

20. The method of claim 15, wherein the contacting step includes the steps of contacting a predefined first section of the optically variable element with the first region of the printing blanket, and contacting a predefined second section of the optically variable element with the second region of the printing blanket.
